(19) United States
(12) Patent Application Publication
(10) Pub. No.: US 2020/0213149 A1
(43) Pub. Date: Jul. 2, 2020

(54) ELECTRONIC CONTROL SYSTEM, ELECTRONIC CONTROL DEVICE, CONTROL METHOD, AND RECORDING MEDIUM

(71) Applicant: PANASONIC INTELLECTUAL PROPERTY MANAGEMENT CO., LTD., Osaka (JP)

(72) Inventors: Akihito TAKEUCHI, Osaka (JP); Kaoru YOKOTA, Hyogo (JP); Takayuki FUJII, Osaka (JP)

(73) Assignee: PANASONIC INTELLECTUAL PROPERTY MANAGEMENT CO., LTD., Osaka (JP)

(21) Appl. No.: 16/723,454

(22) Filed: Dec. 20, 2019

Related U.S. Application Data
(60) Provisional application No. 62/785,138, filed on Dec. 26, 2018.

(51) Int. Cl. H04L 12/40; B60W 30/16; B60R 16/023

(52) U.S. Cl. CPC H04L 12/40163; B60W 30/16; H04L 2012/40215; B60R 16/0231; H04L 12/40156

(57) ABSTRACT

An electronic control system includes: a CAN bus included in a vehicle; an ADAS control ECU that receives a vehicle state signal indicating information about a state of the vehicle via a dedicated line which is wiring used only for communication of the vehicle state signal, and transmits a control instruction signal to the CAN bus based on the vehicle state signal; and an actuator ECU that receives, via the CAN bus, the control instruction signal transmitted from the ADAS control ECU, and performs control relating to driving of the vehicle based on the control instruction signal.

### CROSS REFERENCE TO RELATED APPLICATION

The present application is based on and claims priority of U.S. Provisional Patent Application No. 62/785,138 filed on Dec. 26, 2018. The entire disclosure of the above-identified application, including the specification, drawings and claims is incorporated herein by reference in its entirety.

### FIELD

The present disclosure relates to an electronic control system, an electronic control device, a control method, and a recording medium.

### BACKGROUND

Electronic control systems that automatically perform driving operations such as acceleration/deceleration, steering, and braking of vehicles are known in recent years. An electronic control system includes a sensor ECU (Electronic Control Unit), an autonomous cruise ECU, and an engine ECU. These ECUs are connected to a common CAN (Controller Area Network) bus.

An example of a process by such an electronic control system will be described below. The sensor ECU transmits, based on sensor data from a sensor for detecting the state of the vehicle, a vehicle state signal indicating information about the state of the vehicle to the CAN bus. The autonomous cruise ECU receives the vehicle state signal transmitted from the sensor ECU via the CAN bus, and transmits an acceleration/deceleration instruction signal to the CAN bus based on the received vehicle state signal. The engine ECU receives the acceleration/deceleration instruction signal transmitted from the autonomous cruise ECU via the CAN bus, and controls the engine based on the received acceleration/deceleration instruction signal.

To enhance security in the electronic control system, a monitoring device that detects unauthorized CAN messages is proposed (for example, see PTL 1). The monitoring device described in PTL 1 determines, upon receiving a CAN message, whether the reception of the CAN message is within a permission period set around a scheduled transmission time, and discards the CAN message in the case where the CAN message is received outside the permission period.

### CITATION LIST

### Patent Literature

PTL 1: International Patent Application Publication No. 2016/080422

### SUMMARY

### Technical Problem

The vehicle provided with the foregoing electronic control system can be subjected to the following attack patterns by malicious third parties: a) an attack pattern of transmitting an unauthorized CAN message disguising as an acceleration/deceleration instruction signal to the engine ECU to unauthorizedly control the engine; and b) an attack pattern of transmitting an unauthorized CAN message disguising as a vehicle state signal to the autonomous cruise ECU to cause the autonomous cruise ECU to wrongly transmit an acceleration/deceleration instruction signal.

In the case where the monitoring device described in PTL 1 is used against the former attack pattern, the acceleration/deceleration instruction signal received by the engine ECU can be discarded because it is an unauthorized CAN message transmitted from an unauthorized ECU or the like in an anomalous cycle.

In the case where the monitoring device described in PTL 1 is used against the latter attack pattern, however, the acceleration/deceleration instruction signal received by the engine ECU cannot be discarded because it is an authorized CAN message transmitted from the autonomous cruise ECU in a normal cycle. Thus, the conventional electronic control system fails to provide sufficient security measures.

The present disclosure has an object of providing an electronic control system, an electronic control device, a control method, and a recording medium that can enhance security measures.

### Solution to Problem

An electronic control system according to an aspect of the present disclosure is an electronic control system that controls a mobility, the electronic control system including: a mobility network included in the mobility; a first electronic control device that receives a state signal indicating information about a state of the mobility via a dedicated line which is wiring used only for communication of the state signal, and transmits a control instruction signal to the mobility network based on the state signal; and a second electronic control device that receives, via the mobility network, the control instruction signal transmitted from the first electronic control device, and performs control relating to driving of the mobility based on the control instruction signal.

These general and specific aspects may be implemented using a system, a method, an integrated circuit, a computer program, or a computer-readable recording medium such as CD-ROM (Compact Disc-Read Only Memory), or any combination of systems, methods, integrated circuits, computer programs, and recording media.

### Advantageous Effects

The electronic control system, etc. according to an aspect of the present disclosure can enhance security measures.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram illustrating a structure of an electronic control system according to an embodiment in normal time in which a vehicle is not attacked.

FIG. 2 is a diagram illustrating an example of conditions for an ADAS control ECU in the electronic control system according to the embodiment to transmit a control instruction signal.

FIG. 3 is a sequence diagram illustrating operation of the electronic control system according to the embodiment in normal time in which the vehicle is not attacked.

FIG. 4 is a block diagram illustrating a structure of the electronic control system according to the embodiment in anomalous time in which the vehicle is attacked.

FIG. 5 is a sequence diagram illustrating operation of the electronic control system according to the embodiment in anomalous time in which the vehicle is attacked.

### DESCRIPTION OF EMBODIMENT

An electronic control system according to an aspect of the present disclosure is an electronic control system that controls a mobility, the electronic control system including: a mobility network included in the mobility; a first electronic control device that receives a state signal indicating information about a state of the mobility via a dedicated line which is wiring used only for communication of the state signal, and transmits a control instruction signal to the mobility network based on the state signal; and a second electronic control device that receives, via the mobility network, the control instruction signal transmitted from the first electronic control device, and performs control relating to driving of the mobility based on the control instruction signal.

With this structure, the first electronic control device receives the state signal only via the dedicated line. Hence, for example, an unauthorized electronic control device connected to the mobility network cannot transmit an unauthorized state signal to the first electronic control device by impersonating an authorized electronic control device. Consequently, wrong transmission of a control instruction signal by the first electronic control device can be prevented, and security measures in the electronic control system can be enhanced.

For example, the second electronic control device may receive, via the mobility network, the control instruction signal transmitted from the first electronic control device, and control an actuator for driving the mobility based on the control instruction signal.

With this structure, as a result of preventing wrong transmission of a control instruction signal by the first electronic control device, unauthorized control of the actuator for driving the mobility can be prevented.

For example, the electronic control system may further include: a sensor control device that is connected to the first electronic control device via the dedicated line, and transmits the state signal to the first electronic control device via the dedicated line.

With this structure, for example, an unauthorized electronic control device connected to the mobility network can be prevented from transmitting an unauthorized state signal to the first electronic control device by impersonating the sensor control device.

For example, the electronic control system may further include: a plurality of third electronic control devices that respectively transmit a plurality of state signals, wherein a third electronic control device that is part of the plurality of third electronic control devices is connected to the first electronic control device via the dedicated line, and an other third electronic control device of the plurality of third electronic control devices is connected to the mobility network.

With this structure, at least one third electronic control device that is part of the plurality of third electronic control devices is connected to the first electronic control device via the dedicated line, so that an increase in the number of dedicated lines can be reduced. Consequently, an increase in the weight of the mobility can be reduced.

For example, the first electronic control device may receive the plurality of state signals transmitted respectively from the plurality of third electronic control devices, and transmit the control instruction signal to the mobility network when the plurality of state signals each satisfy a corresponding condition.

With this structure, the first electronic control device transmits the control instruction signal to the mobility network in the case where the plurality of state signals each satisfy the corresponding condition. Thus, for example, even in the case where an unauthorized state signal disguising as a state signal of the plurality of state signals is transmitted to the mobility network, the first electronic control device does not transmit the control instruction signal unless a condition corresponding to an authorized state signal transmitted from the third electronic control device to the dedicated line is satisfied. Consequently, wrong transmission of a control instruction signal by the first electronic control device can be prevented more reliably.

An electronic control device according to an aspect of the present disclosure is an electronic control device connected to a mobility network included in a mobility, the electronic control device including: a receiver that receives a state signal indicating information about a state of the mobility, via a dedicated line which is wiring used only for communication of the state signal; and a transmitter that transmits, to an other electronic control device that performs control relating to driving of the mobility, a control instruction signal for the other electronic control device to perform control relating to driving of the mobility, via the mobility network.

With this structure, the receiver receives the state signal only via the dedicated line. Hence, for example, an unauthorized electronic control device connected to the mobility network cannot transmit an unauthorized state signal to the receiver by impersonating an authorized electronic control device. Consequently, wrong transmission of a control instruction signal by the transmitter can be prevented, and security measures can be enhanced.

A control method according to an aspect of the present disclosure is a control method in an electronic control system that controls a mobility, the electronic control system including: a mobility network included in the mobility; a first electronic control device connected to a dedicated line which is wiring used only for communication of a state signal indicating information about a state of the mobility, and connected to the mobility network; and a second electronic control device connected to the mobility network, the control method including: receiving, by the first electronic control device, the state signal via the dedicated line; transmitting, by the first electronic control device, a control instruction signal to the mobility network based on the state signal; receiving, by the second electronic control device, the control instruction signal transmitted from the first electronic control device, via the mobility network; and performing, by the second electronic control device, control relating to driving of the mobility based on the control instruction signal.

With this structure, the first electronic control device receives the state signal only via the dedicated line. Hence, for example, an unauthorized electronic control device connected to the mobility network cannot transmit an unauthorized state signal to the first electronic control device by impersonating an authorized electronic control device. Consequently, wrong transmission of a control instruction signal by the first electronic control device can be prevented, and security measures in the electronic control system can be enhanced.

A recording medium according to an aspect of the present disclosure is a non-transitory computer-readable recording medium for use in a computer, the recording medium having a computer program recorded thereon for causing the computer to execute the foregoing control method.

These general and specific aspects may be implemented using a system, a method, an integrated circuit, a computer program, or a computer-readable recording medium such as CD-ROM, or any combination of systems, methods, integrated circuits, computer programs, and recording media.

An embodiment will be described in detail below, with reference to the drawings.

The embodiment described below shows a general or specific example. The numerical values, shapes, materials, structural elements, the arrangement and connection of the structural elements, steps, the processing order of the steps etc. shown in the following embodiment are mere examples, and do not limit the scope of the present disclosure. Of the structural elements in the embodiment described below, the structural elements not recited in any one of the independent claims representing the broadest concepts are described as optional structural elements.

### Embodiment

### [1. Structure of Electronic Control System]

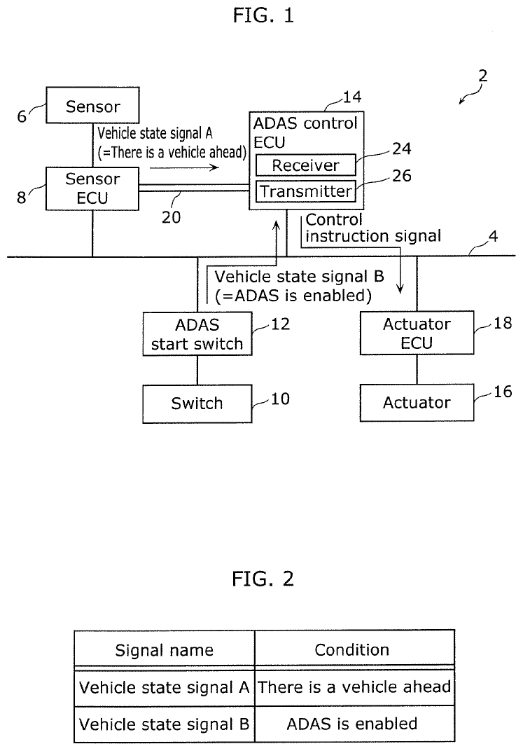

A structure of electronic control system 2 according to the embodiment will be described below, with reference to FIGS. 1 and 2. FIG. 1 is a block diagram illustrating a structure of electronic control system 2 according to the embodiment in normal time in which a vehicle is not attacked. FIG. 2 is a diagram illustrating an example of conditions for ADAS control ECU 14 in electronic control system 2 according to the embodiment to transmit a control instruction signal.

Electronic control system 2 according to this embodiment is a system that controls the vehicle to automatically perform driving operations such as acceleration/deceleration, steering, and braking of the vehicle, and is included in the vehicle. The vehicle is an example of a mobility. For example, the vehicle is an automobile.

As illustrated in FIG. 1, electronic control system 2 includes CAN bus 4, sensor 6, sensor ECU 8, switch 10, ADAS start switch 12, ADAS control ECU 14, actuator 16, and actuator ECU 18.

CAN bus 4 is an in-vehicle network for communicating CAN messages according to a CAN protocol, and is included in the vehicle. CAN bus 4 is an example of a mobility network.

A CAN message is a data frame defined in the CAN protocol. For example, the CAN message is composed of the following fields: start of frame (SOF), identification (ID) field, remote transmission request (RTR), control field, data field, cyclic redundancy check (CRC) field, acknowledgement (ACK) field, and end of frame (EOF).

Sensor 6 is, for example, a LiDAR (light detection and ranging) system for detecting objects around the vehicle using a laser. Sensor 6 is connected to sensor ECU 8. Sensor 6 outputs sensor data indicating the inter-vehicle distance between the vehicle and a vehicle running ahead of the vehicle, to sensor ECU 8.

Sensor ECU 8 is an ECU that transmits a vehicle state signal (hereafter referred to as “vehicle state signal A”) based on the sensor data from sensor 6. Sensor ECU 8 is an example of a third electronic control device and a sensor control device. Sensor ECU 8 is connected to CAN bus 4 and also connected to ADAS control ECU 14 via dedicated line 20, and transmits vehicle state signal A to dedicated line 20. Dedicated line 20 is wiring used only for communication between sensor ECU 8 and ADAS control ECU 14, and is, for example, Ethernet®.

Vehicle state signal A is a CAN message indicating information about the state of the vehicle. Vehicle state signal A is an example of a state signal. Specifically, vehicle state signal A is a CAN message indicating information about the inter-vehicle distance, i.e. information about whether there is a vehicle ahead.

Sensor ECU 8 transmits vehicle state signal A indicating that there is no vehicle ahead to dedicated line 20, in the case where the inter-vehicle distance is greater than or equal to a predetermined distance. Sensor ECU 8 transmits vehicle state signal A indicating that there is a vehicle ahead to dedicated line 20, in the case where the inter-vehicle distance is less than the predetermined distance.

Switch 10 is, for example, a user interface for enabling or disabling an advanced driver assistance system (ADAS) such as adaptive cruise control (ACC). ACC is a function of automatically performing accelerator operation and brake operation of the vehicle depending on the inter-vehicle distance, the vehicle speed, and the like. Switch 10 is, for example, located at an instrument panel of the vehicle, and operated by the driver of the vehicle. For example, to enable the ADAS, the driver operates switch 10 to turn on the ADAS. To disable the ADAS, the driver operates switch 10 to turn off the ADAS. Switch 10 is connected to ADAS start switch 12. Switch outputs a switch signal indicating whether the ADAS is enabled or disabled, to ADAS start switch 12.

ADAS start switch 12 is an ECU that transmits a vehicle state signal (hereafter referred to as “vehicle state signal B”) based on the switch signal from switch 10. ADAS start switch 12 is an example of a third electronic control device and a sensor control device. ADAS start switch 12 is connected to CAN bus 4, and transmits vehicle state signal B to CAN bus 4.

Vehicle state signal B is a CAN message indicating information about the state of the vehicle. Vehicle state signal B is an example of a state signal. Specifically, vehicle state signal B is a CAN message indicating information about whether the ADAS is enabled or disabled.

ADAS start switch 12 transmits vehicle state signal B indicating that the ADAS is enabled to CAN bus 4, in the case where the ADAS is enabled by the driver operating switch 10. ADAS start switch 12 transmits vehicle state signal B indicating that the ADAS is disabled to CAN bus 4, in the case where the ADAS is disabled by the driver operating switch 10.

ADAS control ECU 14 is an ECU that transmits a control instruction signal in the case where vehicle state signal A and vehicle state signal B each satisfy a corresponding condition. ADAS control ECU 14 is an example of a first electronic control device and an electronic control device. ADAS control ECU 14 is connected to CAN bus 4, and also connected to sensor ECU 8 via dedicated line 20. ADAS control ECU 14 includes receiver 24 and transmitter 26. Receiver 24 in ADAS control ECU 14 receives vehicle state signal A transmitted from sensor ECU 8, via dedicated line 20. Vehicle state signal A is transmitted/received only between sensor ECU 8 and receiver 24 in ADAS control ECU 14 via dedicated line 20. Receiver 24 in ADAS control ECU 14 also receives vehicle state signal B transmitted from ADAS start switch 12, via CAN bus 4.

As illustrated in FIG. 2, in the case where vehicle state signal A satisfies a condition “there is a vehicle ahead” and vehicle state signal B satisfies a condition “ADAS is enabled”, transmitter 26 in ADAS control ECU 14 transmits a control instruction signal to CAN bus 4. In the case where at least one of vehicle state signal A and vehicle state signal B does not satisfy the corresponding condition, transmitter 26 in ADAS control ECU 14 does not transmit a control instruction signal to CAN bus 4.

The expression “transmit a control instruction signal” in the case where vehicle state signal A satisfies the condition “there is a vehicle ahead” and vehicle state signal B satisfies the condition “ADAS is enabled” includes not only simply transmitting the control instruction signal but also transmitting the control instruction signal in a state in which the value of the control instruction signal is a valid value. The expression “not transmit a control instruction signal” in the case where at least one of vehicle state signal A and vehicle state signal B does not satisfy the corresponding condition includes not only simply not transmitting the control instruction signal but also transmitting the control instruction signal in a state in which the value of the control instruction signal is an invalid value or an initial value.

Actuator 16 is a mechanism for driving the vehicle. Examples of actuator 16 include: a) an accelerator actuator for driving the accelerator; b) a brake actuator for driving the brake; c) a steering actuator for driving the steering; and d) an engine actuator for driving the engine. Actuator 16 is connected to actuator ECU 18.

Actuator ECU 18 is an ECU that performs control relating to driving of the vehicle based on the control instruction signal from ADAS control ECU 14. Actuator ECU 18 is an example of a second electronic control device. Specifically, actuator ECU 18 controls actuator 16 based on the control instruction signal from ADAS control ECU 14. Actuator ECU 18 is connected to CAN bus 4, and receives, via CAN bus 4, the control instruction signal transmitted from ADAS control ECU 14. For example, in the case where actuator 16 is a steering actuator, actuator ECU 18 controls the steering by controlling actuator 16 based on the control instruction signal from ADAS control ECU 14.

### [2. Operation of Electronic Control System]

### [2-1. Operation of Electronic Control System in Normal Time]

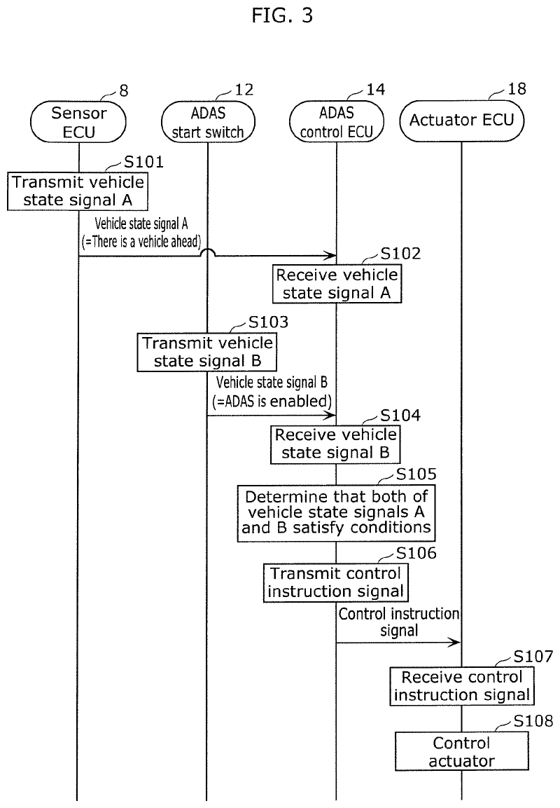

Operation of electronic control system 2 in normal time in which the vehicle is not attacked will be described below, with reference to FIGS. 1 and 3. FIG. 3 is a sequence diagram illustrating operation of electronic control system 2 according to the embodiment in normal time in which the vehicle is not attacked.

The following will describe the case where the driver turns on a function “constant inter-vehicle distance cruise” as the function of ACC. The constant inter-vehicle distance cruise function is a function of performing, when there is a vehicle ahead, control to keep the inter-vehicle distance from the vehicle ahead constant. The constant inter-vehicle distance cruise function is activated in the case where a) there is a vehicle ahead and b) the ADAS is enabled (i.e. in the case where vehicle state signal A and vehicle state signal B both satisfy the corresponding conditions).

As illustrated in FIGS. 1 and 3, in the case where the inter-vehicle distance between the vehicle and a vehicle ahead is less than the predetermined distance, sensor ECU 8 transmits vehicle state signal A indicating that there is a vehicle ahead to dedicated line 20 (S101). ADAS control ECU 14 receives vehicle state signal A transmitted from sensor ECU 8, via dedicated line 20 (S102).

In the case where the ADAS is enabled by the driver operating switch 10, ADAS start switch 12 transmits vehicle state signal B indicating that the ADAS is enabled, to CAN bus 4 (S103). ADAS control ECU 14 receives vehicle state signal B transmitted from ADAS start switch 12, via CAN bus 4 (S104).

ADAS control ECU 14 determines that vehicle state signal A satisfies the condition “there is a vehicle ahead” and vehicle state signal B satisfies the condition “ADAS is enabled” (S105). Based on the determination result, ADAS control ECU 14 determines that actuator ECU 18 needs to be controlled to perform constant inter-vehicle distance cruise, and transmits a control instruction signal for instructing actuator ECU 18 to perform constant inter-vehicle distance cruise to CAN bus 4 (S106).

Actuator ECU 18 receives the control instruction signal transmitted from ADAS control ECU 14, via CAN bus 4 (S107). Based on the control instruction signal from ADAS control ECU 14, actuator ECU 18 controls actuator 16 (e.g. the accelerator actuator and the brake actuator) to perform constant inter-vehicle distance cruise (S108).

### [2-2. Operation of Electronic Control System in Anomalous Time]

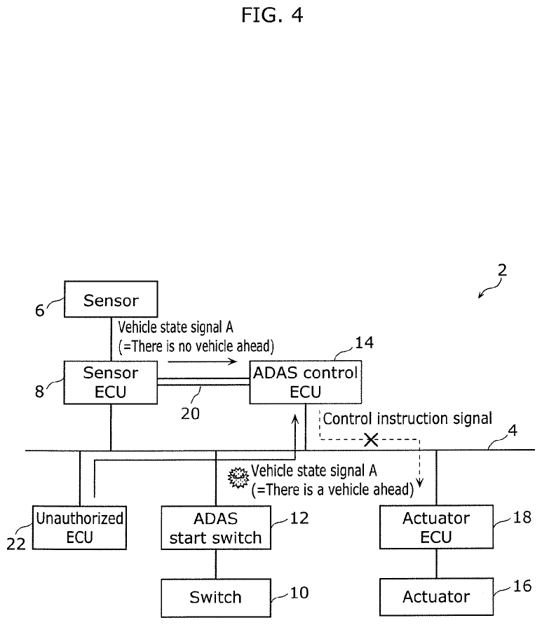

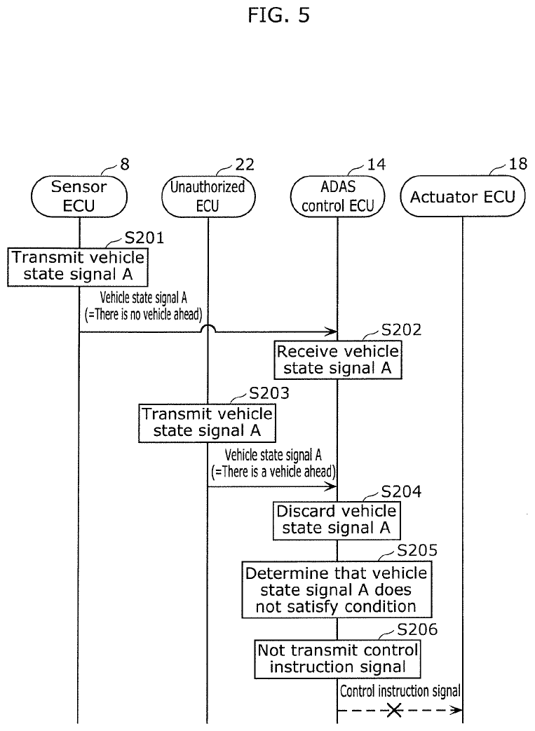

Operation of electronic control system 2 in anomalous time in which the vehicle is attacked will be described below, with reference to FIGS. 4 and 5. FIG. 4 is a block diagram illustrating a structure of electronic control system 2 according to the embodiment in anomalous time in which the vehicle is attacked. FIG. 5 is a sequence diagram illustrating operation of electronic control system 2 according to the embodiment in anomalous time in which the vehicle is attacked. Receiver 24 and transmitter 26 are not illustrated in FIG. 4, for the sake of convenience.

The following will describe the case where a malicious third party attempts an attack of transmitting an unauthorized CAN message disguising as vehicle state signal A to ADAS control ECU 14 to cause ADAS control ECU 14 to wrongly transmit a control instruction signal. As illustrated in FIG. 4, unauthorized ECU 22 used by the malicious third party to attack the vehicle is connected to CAN bus 4.

As illustrated in FIG. 5, sensor ECU 8 transmits vehicle state signal A indicating that there is no vehicle ahead to dedicated line 20 (S201). ADAS control ECU 14 receives vehicle state signal A transmitted from sensor ECU 8, via dedicated line 20 (S202).

As illustrated in FIGS. 4 and 5, unauthorized ECU 22 impersonates sensor ECU 8, and transmits unauthorized vehicle state signal A indicating that there is a vehicle ahead to CAN bus 4 (S203). That is, despite there being actually no vehicle ahead, unauthorized vehicle state signal A indicating that there is a vehicle ahead is transmitted to CAN bus 4. ADAS control ECU 14 discards unauthorized vehicle state signal A transmitted from unauthorized ECU 22, because it is not transmitted via dedicated line 20 (S204).

ADAS control ECU 14 determines that vehicle state signal A does not satisfy the condition “there is a vehicle ahead” (S205). Here, even in the case where ADAS control ECU 14 receives vehicle state signal B indicating that the ADAS is enabled from ADAS control switch 12, ADAS control ECU 14 determines, based on the determination result, that actuator ECU 18 does not need to be controlled to perform constant inter-vehicle distance cruise. Hence, ADAS control ECU 14 does not transmit a control instruction signal for instructing actuator ECU 18 to perform constant inter-vehicle distance cruise, to CAN bus 4 (S206).

Thus, ADAS control ECU 14 is prevented from wrongly determining that actuator ECU 18 needs to be controlled to perform constant inter-vehicle distance cruise. Unauthorized execution of constant inter-vehicle distance cruise against the driver's intention is therefore prevented.

### [3. Effects]

As described above, vehicle state signal A is transmitted/received only between sensor ECU 8 and ADAS control ECU 14 via dedicated line 20. Accordingly, even in the case where unauthorized ECU 22 impersonates sensor ECU 8 and transmits unauthorized vehicle state signal A indicating that there is a vehicle ahead, ADAS control ECU 14 can discard unauthorized vehicle state signal A because it is not transmitted via dedicated line 20. That is, ADAS control ECU 14 can be prevented from receiving unauthorized vehicle state signal A indicating that there is a vehicle ahead, despite there being actually no vehicle ahead.

Consequently, unauthorized execution of constant inter-vehicle distance cruise as a result of the ADAS being enabled against the driver's intention is prevented. This enhances security measures in electronic control system 2.

### (Variations)

While an electronic control system, an electronic control device, and a control method according to one or more aspects have been described above by way of the foregoing embodiment, the present disclosure is not limited to the foregoing embodiment. Other modifications obtained by applying various changes conceivable by a person skilled in the art to the foregoing embodiment and any combinations of the structural elements in different embodiments without departing from the scope of the present disclosure are also included in the scope of one or more aspects.

Although the foregoing embodiment describes, as an example of application of the electronic control system according to the present disclosure, application to security measures in an in-vehicle network included in a vehicle such as an automobile, the range of application of electronic control system according to the present disclosure is not limited to such. The electronic control system according to the present disclosure is usable not only in vehicles such as automobiles but also in any mobilities such as construction machines, farm machines, ships, railways, and planes.

Although the foregoing embodiment describes the case where sensor ECU 8 and ADAS control ECU 14 are connected by dedicated line 20, the present disclosure is not limited to this. Sensor ECU 8 and ADAS control ECU 14 may be connected by dedicated line 20, and ADAS start switch 12 and ADAS control ECU 14 connected by another dedicated line. In such a case, vehicle state signal A is transmitted/received only between sensor ECU 8 and ADAS control ECU 14 via dedicated line 20, and vehicle state signal B is transmitted/received only between ADAS start switch 12 and ADAS control ECU 14 via another dedicated line. This further enhances security measures in electronic control system 2.

Although the foregoing embodiment describes the case where sensor ECU 8 transmits vehicle state signal A to dedicated line 20, the present disclosure is not limited to this. Sensor ECU 8 may transmit vehicle state signal A to dedicated line 20, and also to CAN bus 4. In such a case, for example, actuator ECU 18 may receive, via CAN bus 4, vehicle state signal A transmitted from sensor ECU 8. ADAS control ECU 14 is preferably configured not to receive vehicle state signal A transmitted from sensor ECU 8 to CAN bus 4.

Although the foregoing embodiment describes the case where sensor ECU 8 is connected to dedicated line 20 and also to CAN bus 4, the present disclosure is not limited to this. Sensor ECU 8 may be connected only to dedicated line 20, and not to CAN bus 4.

Although the foregoing embodiment describes the case where two ECUs (sensor ECU 8 and ADAS start switch 12) are provided as third electronic control devices (sensor control devices), the present disclosure is not limited to this, and three or more ECUs may be provided. In such a case, at least one of a plurality of ECUs as third electronic control devices (sensor control devices) is connected to ADAS control ECU 14 via dedicated line 20.

Although the foregoing embodiment describes the case where sensor 6 is a LiDAR system, the present disclosure is not limited to this. For example, sensor 6 may be any sensor such as a millimeter wave sensor or a camera sensor.

Although the foregoing embodiment describes the case where vehicle state signal A is a CAN message indicating information about the inter-vehicle distance (i.e. information about whether there is a vehicle ahead), the present disclosure is not limited to this. For example, vehicle state signal A may be a CAN message indicating information about the vehicle speed of the vehicle.

Although the foregoing embodiment describes the case where the driver turns on the constant inter-vehicle distance cruise function as the function of ACC, the present disclosure is not limited to this. For example, as the function of ACC, a function “constant vehicle speed cruise” of performing control to keep the vehicle speed constant may be turned on when there is no vehicle ahead. This constant vehicle speed cruise function is activated in the case where a) there is no vehicle ahead, b) the vehicle speed of the vehicle is greater than or equal to a predetermined value, and c) the ADAS is enabled. In such a case, as third electronic control devices (sensor control devices), not only sensor ECU 8 and ADAS start switch 12 but also a sensor ECU that transmits vehicle state signal C indicating information about the vehicle speed based on sensor data from a vehicle speed sensor may be provided. In the case where vehicle state signal A satisfies the condition “there is a vehicle ahead”, vehicle state signal B satisfies the condition “ADAS is enabled”, and vehicle state signal C satisfies the condition “vehicle speed is greater than or equal to predetermined value”, ADAS control ECU 14 transmits a control instruction signal to CAN bus 4.

Each of the structural elements in the foregoing embodiment may be configured in the form of an exclusive hardware product, or may be realized by executing a software program suitable for the structural element. Each of the structural elements may be realized by means of a program executing unit, such as a CPU and a processor, reading and executing the software program recorded on a recording medium such as a hard disk or semiconductor memory.

Part or all of the functions of the electronic control system according to the foregoing embodiment may be implemented by a processor such as a CPU executing a program.

Part or all of the structural elements constituting each device may be configured as an IC card detachably mountable to the device or a standalone module. The IC card or the module is a computer system including a microprocessor, ROM, RAM, and so forth. The IC card or the module may include the above-described super-multifunctional LSI. The IC card or the module achieves its functions by the microprocessor operating according to the computer program. The IC card or the module may be tamper-resistant.

The present disclosure may be implemented as the method described above. The present disclosure may be a computer program which realizes these methods by a computer, or may be digital signals made up of the computer program. The present disclosure may be the computer program or the digital signals recorded in a computer-readable recording medium, such as flexible disk, hard disk, CD-ROM, MO, DVD, DVD-ROM, DVD-RAM, Blu-ray® disc (BD), or semiconductor memory. The present disclosure may also be the digital signals recorded in these recording media. The present disclosure may be an arrangement where the computer program or the digital signals are transmitted over an electric communication line, a wireless or wired communication line, a network such as the Internet, data broadcasting, or the like. The present disclosure may be a computer system having a microprocessor and memory, where the memory records the computer program, and the microprocessor operates according to the computer program. The present disclosure may also be carried out by another independent computer system, by the program or the digital signals being recorded in the recording medium and being transported, or by the program or the digital signals being transferred over the network or the like.

Although only an exemplary embodiment of the present invention has been described in detail above, those skilled in the art will readily appreciate that many modifications are possible in the exemplary embodiment without materially departing from the novel teachings and advantages of the present disclosure. Accordingly, all such modifications are intended to be included within the scope of the present disclosure.

### INDUSTRIAL APPLICABILITY

The electronic control system according to the present disclosure is useful, for example, in a system for automatically performing driving operations of a vehicle.

1. An electronic control system that controls a mobility, the electronic control system comprising:
a mobility network included in the mobility;
a first electronic control device that receives a state signal indicating information about a state of the mobility via a dedicated line which is wiring used only for communication of the state signal, and transmits a control instruction signal to the mobility network based on the state signal; and
a second electronic control device that receives, via the mobility network, the control instruction signal transmitted from the first electronic control device, and performs control relating to driving of the mobility based on the control instruction signal.

2. The electronic control system according to claim 1,
wherein the second electronic control device receives, via the mobility network, the control instruction signal transmitted from the first electronic control device, and controls an actuator for driving the mobility based on the control instruction signal.

3. The electronic control system according to claim 1, further comprising:
a sensor control device that is connected to the first electronic control device via the dedicated line, and transmits the state signal to the first electronic control device via the dedicated line.

4. The electronic control system according to claim 1, further comprising:
a plurality of third electronic control devices that respectively transmit a plurality of state signals,
wherein a third electronic control device that is part of the plurality of third electronic control devices is connected to the first electronic control device via the dedicated line, and
an other third electronic control device of the plurality of third electronic control devices is connected to the mobility network.

5. The electronic control system according to claim 4,
wherein the first electronic control device receives the plurality of state signals transmitted respectively from the plurality of third electronic control devices, and transmits the control instruction signal to the mobility network when the plurality of state signals each satisfy a corresponding condition.

6. An electronic control device connected to a mobility network included in a mobility, the electronic control device comprising:
a receiver that receives a state signal indicating information about a state of the mobility, via a dedicated line which is wiring used only for communication of the state signal; and
a transmitter that transmits, to an other electronic control device that performs control relating to driving of the mobility, a control instruction signal for the other electronic control device to perform control relating to driving of the mobility, via the mobility network.

7. A control method in an electronic control system that controls a mobility, the electronic control system including: a mobility network included in the mobility; a first electronic control device connected to a dedicated line which is wiring used only for communication of a state signal indicating information about a state of the mobility, and connected to the mobility network; and a second electronic control device connected to the mobility network, the control method comprising:
receiving, by the first electronic control device, the state signal via the dedicated line;
transmitting, by the first electronic control device, a control instruction signal to the mobility network based on the state signal;
receiving, by the second electronic control device, the control instruction signal transmitted from the first electronic control device, via the mobility network; and
performing, by the second electronic control device, control relating to driving of the mobility based on the control instruction signal.

8. A non-transitory computer-readable recording medium for use in a computer, the recording medium having a computer program recorded thereon for causing the computer to execute the control method according to claim 7.
